(19) United States
(12) Patent Application Publication
(10) Pub. No.: US 2011/0042911 A1
(43) Pub. Date: Feb. 24, 2011

(54) CART WITH FLEXIBLE CABLE CARRIER

(75) Inventors: William Jacob Kozlowski, JR., Tega Cay, SC (US); Benjamin Shane Bustle, Charlotte, NC (US); Jeffrey Allen Chochinov, Charlotte, NC (US); Robert Grant McRorie, III, Huntersville, NC (US)

Correspondence Address: FOLEY AND LARDNER LLP;SUITE 500, 3000 K STREET NW, WASHINGTON, DC, 20007, US

(73) Assignee: Rubbermaid Incorporated

(21) Appl. No.: 12/665,225

(22) PCT Filed: Jun. 17, 2008
(86) PCT No.: PCT/US08/67226

§ 371 Date: Nov. 12, 2010

Related U.S. Application Data
(60) Provisional application No. 60/944,604, filed on Jun. 18, 2007.

(51) Int. Cl. B60P 1/44

(52) U.S. Cl. 280/47.35

(57) ABSTRACT

The cart (1) disclosed herein may comprise a vertically moveable work station (10) with a platform (12), a column (14) for supporting the work station, at least one cable (26), and a flexible cable carrier (28). The column may include a vertically fixed part and a vertically moveable part that can be moved vertically relative to the vertically fixed part to cause vertical movement of the work station. The column has a vertically oriented opening therein. The at least one cable may be disposed within the vertically oriented opening in the column. The flexible cable carrier may be disposed within the vertically oriented opening in the column. The at least one cable may be connected to the flexible cable carrier and the flexible cable carrier is configured to cause the at least one cable to follow a substantially consistent path during repeated vertical movements of the work station.

### CROSS-REFERENCE TO RELATED PATENT APPLICATIONS

The present application claims priority to U.S. Priority Provisional Application No. 60/944,604 (filed Jun. 18, 2007), the aforementioned application including the specification, drawings, claims and abstract, is hereby incorporated herein by reference in its entirety.

### BACKGROUND

The present invention relates generally to a cart comprising a work station with a flexible cable carrier and, in particular, to such a cart with a flexible cable carrier used to cause at least one cable to follow a substantially consistent path during repeated vertical movements of the work station.

Carts equipped with lift mechanisms are known to allow users to adjust the height of a work station on the cart for a particular application or user height. The cart can include a column with a lift mechanism that allows the user to move the work station along a vertical axis and then be fixed into place on the vertical axis. Some manufacturers pre-wire the column during the assembly process but the wiring is limited to power cables and the cables are only located at the top of the column, in the same location as the on-board peripherals. Carts having peripherals located at the bottom of the cart often have external cables running on the outside of the column, which is disadvantageous.

U.S. Patent Application Publication 2004/0250635 discloses a mechanism that can be used as a lifting force in a video monitor lift application.

### SUMMARY

An embodiment of the present invention includes a cart, which may comprise a vertically moveable work station with a platform, a column for supporting the work station, at least one cable, and a flexible cable carrier. The column may include a vertically fixed part and a vertically moveable part that can be moved vertically relative to the vertically fixed part to cause vertical movement of the work station. The column has a vertically oriented opening therein. The at least one cable may be disposed within the vertically oriented opening in the column The flexible cable carrier may be disposed within the vertically oriented opening in the column. The at least one cable may be connected to the flexible cable carrier and the flexible cable carrier is configured to cause the at least one cable to follow a substantially consistent path during repeated vertical movements of the work station.

It is to be understood that both the foregoing general description and the following detailed description are exemplary and explanatory only, and are not restrictive of the invention as claimed.

These and other features, aspects and advantages of the present invention will become apparent from the following description, appended claims, and the accompanying exemplary embodiments shown in the drawings, which are briefly described below.

### BRIEF DESCRIPTION OF THE DRAWINGS

FIG. 1 is a front perspective view of a cart according to an embodiment of the present invention in a raised position.

FIG. 2 is a front perspective view of the cart of FIG. 1 in a lowered position.

FIG. 3 is a front perspective view of the column of the cart of FIG. 1 with the work station and base removed.

FIGS. 4A and 4B are front perspective and top cross-section views of the column of FIG. 1 in which only the internal structure of the fixed part and the flexible cable carrier are shown.

FIG. 5 is a perspective view of a link of the flexible cable carrier

FIG. 6 is a perspective view of the flexible cable carrier once the links of the flexible cable carrier are assembled.

FIG. 7 is a perspective view of a portion of the flexible cable carrier with an end piece that connects to the vertically fixed part of the column.

FIG. 8 is a perspective view of a portion of the flexible cable carrier with an end piece that connects to the vertically moveable part of the column.

FIG. 9 is a cut-away view of the column showing the placement of the flexible cable carrier therein.

FIG. 10 is a close-up of the flexible cable carrier of FIG. 9.

FIG. 11 is a perspective view of the configuration of the flexible cable carrier when the cart is in the lowered position.

### DETAILED DESCRIPTION OF PREFERRED EMBODIMENTS

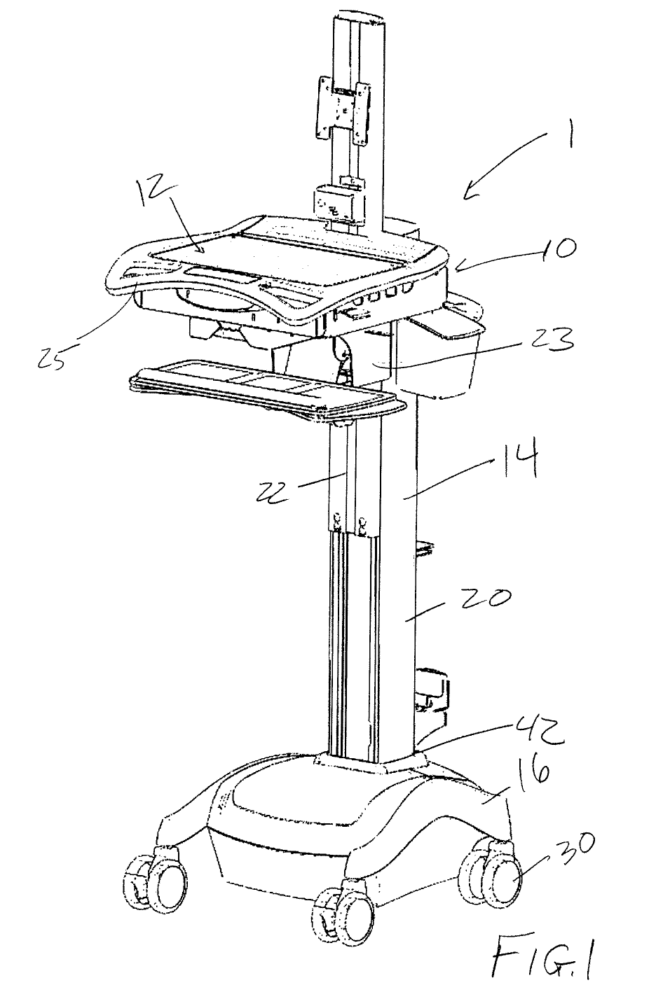

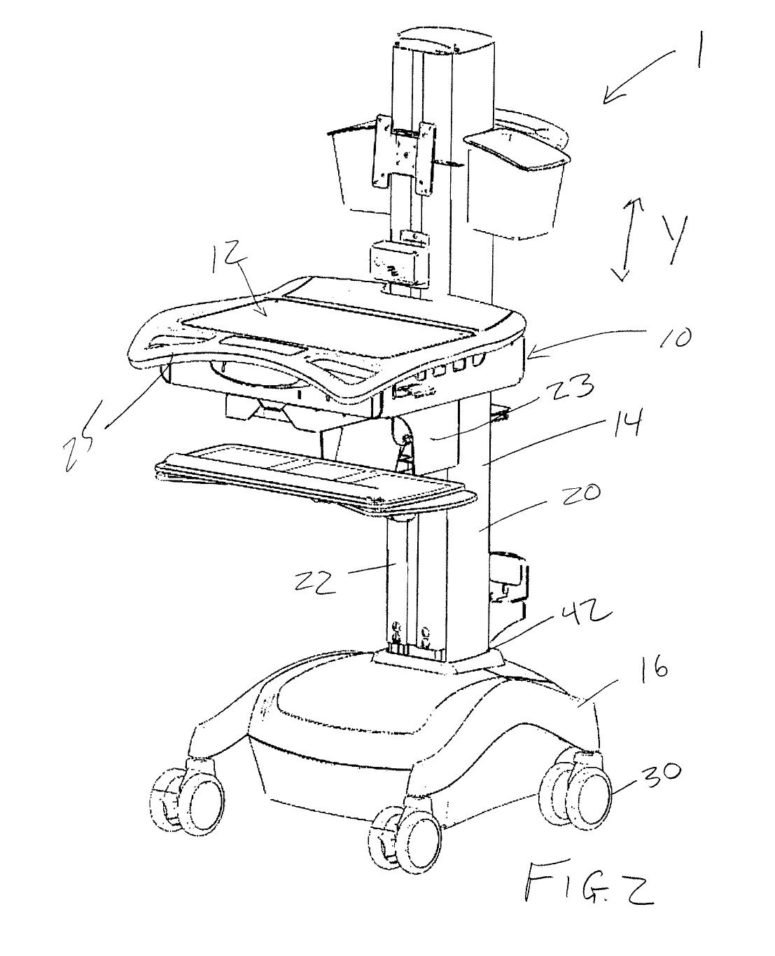

Embodiments of the present invention will now be described with reference to the drawings. FIGS. 1 and 2 show an embodiment of a cart 1 according to the present invention in a raised position and a lowered position, respectively. The cart 1 may comprise a work station 10, a column 14, and a base 16.

The work station 10 moves substantially vertically and comprises a platform 12. The platform 12 may be used to support a keyboard, a mouse, a monitor, a whole computer, or any other suitable apparatus. As seen in FIG. 1, the platform may include handles 25, if desired.

The column 14 supports the work station 10. The column 14 includes a vertically fixed part 20 and a vertically moveable part 22 that can be moved vertically relative to the vertically fixed part 20 to cause vertical movement of the work station 10. A lift mechanism, such as one of those disclosed in U.S. application Ser. No. 12/010,518, filed Jan. 25, 2008 (that application is incorporated herein by reference in its entirety), may be used so as to allow the moveable part to move along the fixed part 20 within a vertical range of motion Y along the fixed column 14. For example, the movable part 14 may translate up and down within a range of about 16 inches. Of course, any suitable distance is contemplated within the invention.

The motion of the movable part 22 is fixed by bearings and rails. For example, two sets of bearings are attached to the movable part 22 that slide within square rails that are incorporated into the fixed part 20. A set of fixed bearings may slide within one rail and a set of floating bearings slide within the other rail. The floating bearings have the ability to float in a floating direction so as to accommodate any variance in the geometry or structure of the rails of the fixed part 22 due to the manufacturing process.

The moveable part 22 may be fixed in a vertical position on the fixed part 20 of the column using a locking mechanism, such as one of those disclosed in U.S. application Ser. No. 12/010,518. According to one embodiment of the present invention, the locking mechanism may comprise a plurality of holes 13 in the fixed part 20, a plunger slidably attached to the movable part 22 for insertion into one of the plurality of holes, and a release lever for releasing and inserting the plunger into the one of the plurality of holes.

The work station 10 may be attached to the movable part 22 by a mounting platform 23. The mounting platform is attached to the movable part 22 through any suitable attaching mechanism, such as screws or rivets. Also, the platform 12 is secured to the mounting platform 23 though any suitable attachment mechanism, such as screws and rivets.

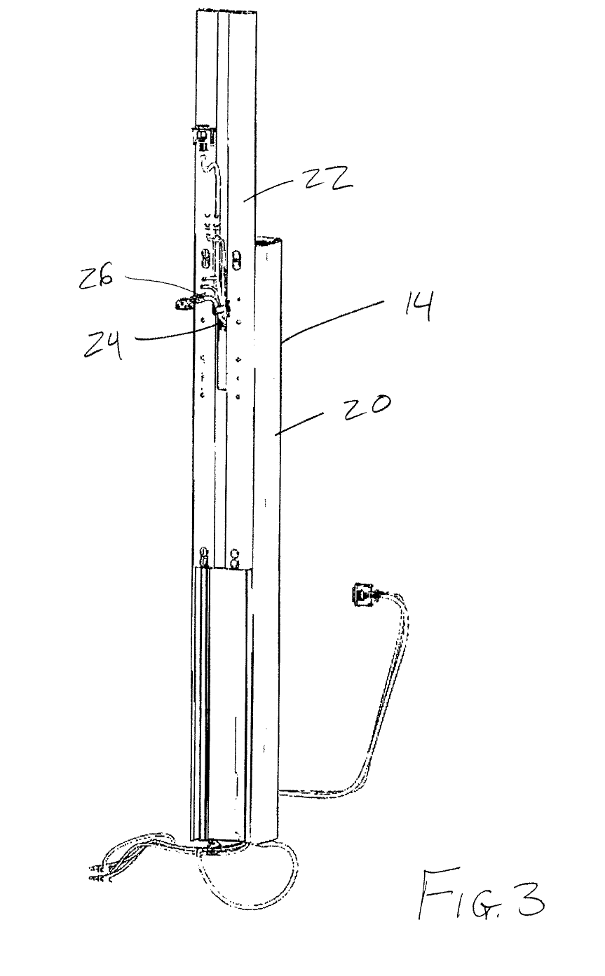

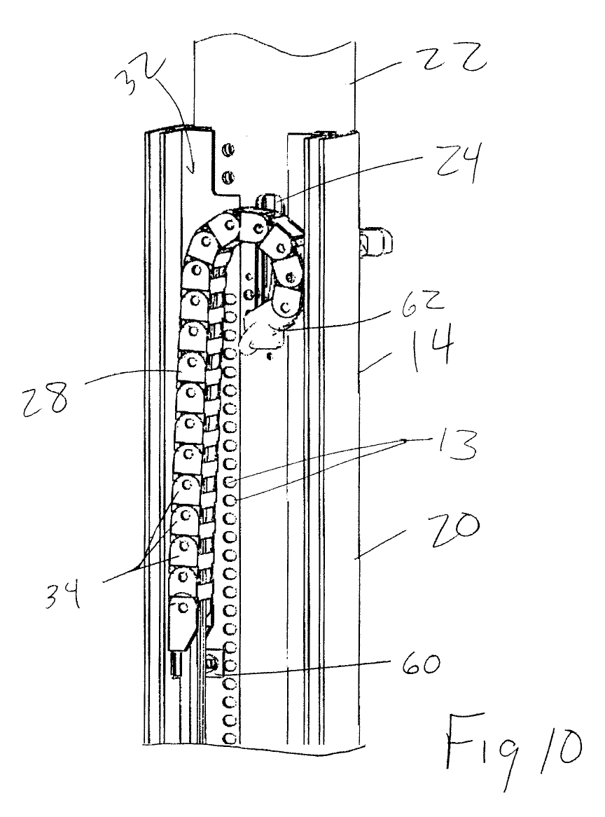

The column 14 can have a vertically oriented opening that preferably extends along substantially the entire vertical length of the column 14. Preferably at least one cable 26 is disposed within that vertically oriented opening and preferably extends along substantially the entire vertical length of the column 14. The vertically oriented opening can be formed by a compartment 32 that separates the cable 26 from other components of the column. The column 14 can also have a slot 24 located therein, as seen in FIGS. 3 and 10, through which cable(s) can project.

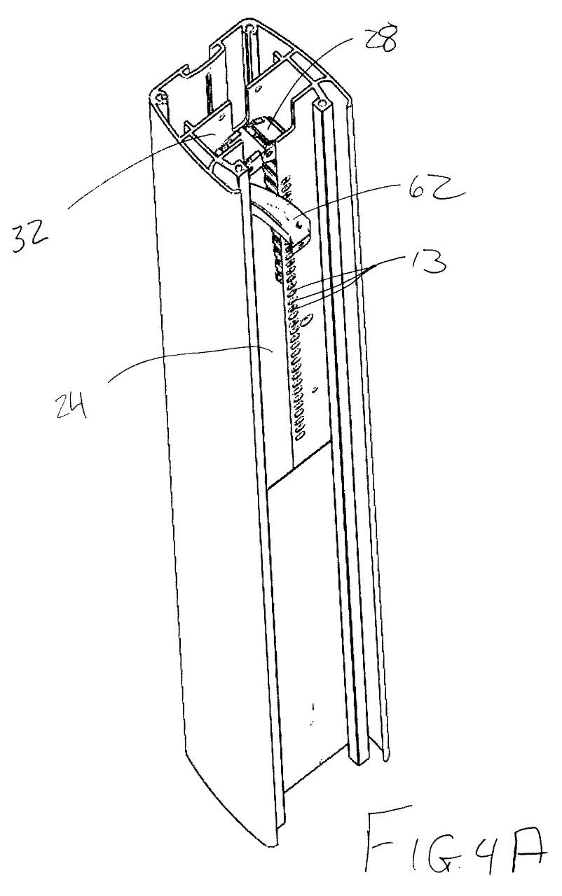

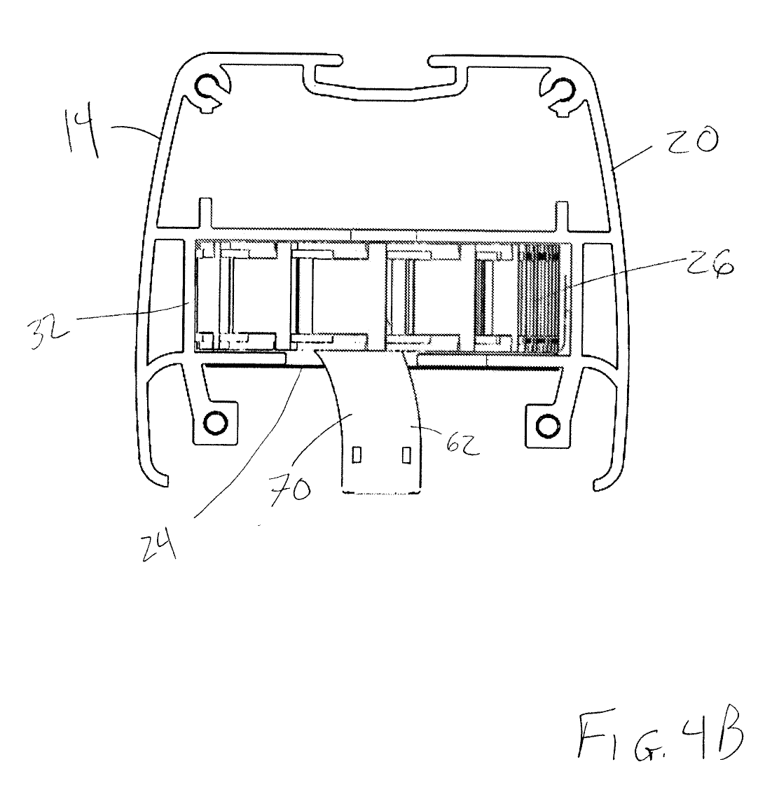

FIGS. 4A and 4B are front perspective and cross-section views of the column 14 showing the internal structure of the fixed part 20 and a flexible cable carrier 28 in which the cable 26 is housed.

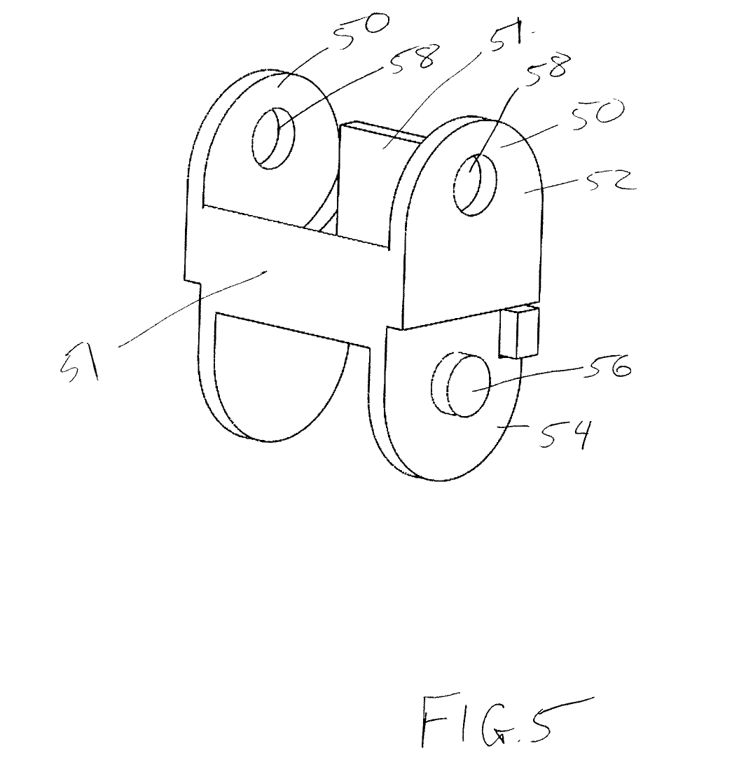

The flexible cable carrier 28 acts as a protective sheath for the one or more cables 26 that may be housed therein. In addition, the flexible cable carrier also assists in the insertion of the cables 26 in the column 14. A preferred embodiment of a flexible cable carrier 28 is disclosed herein, however, other configurations of a flexible cable carrier could be used. The flexible cable carrier 28 can include a plurality of links 34 that move relative to one another to provide flexibility of the flexible cable carrier 28. FIG. 5 is a perspective view of a link 34 of the flexible cable carrier. The links include two side walls 50 in a stepped formation and two adjoining walls 51 connecting the two side walls 50. The upper portions 52 of the side walls 50 are spaced farther apart than the lower portions 54 such that the lower portions 54 of an adjoining link 34 can fit between the upper portions 52. The lower portions 54 have protrusions 56 disposed on their respective outer surfaces while the upper portions 52 have apertures 58. The protrusions 56 of the link fit inside the apertures of an adjoining link when the lower portions 54 are placed between the upper portions of the adjoining link. The flexible cable carrier 28 is made of a suitable material that may allow the assembly of the links, such as rubber, plastic, or the like.

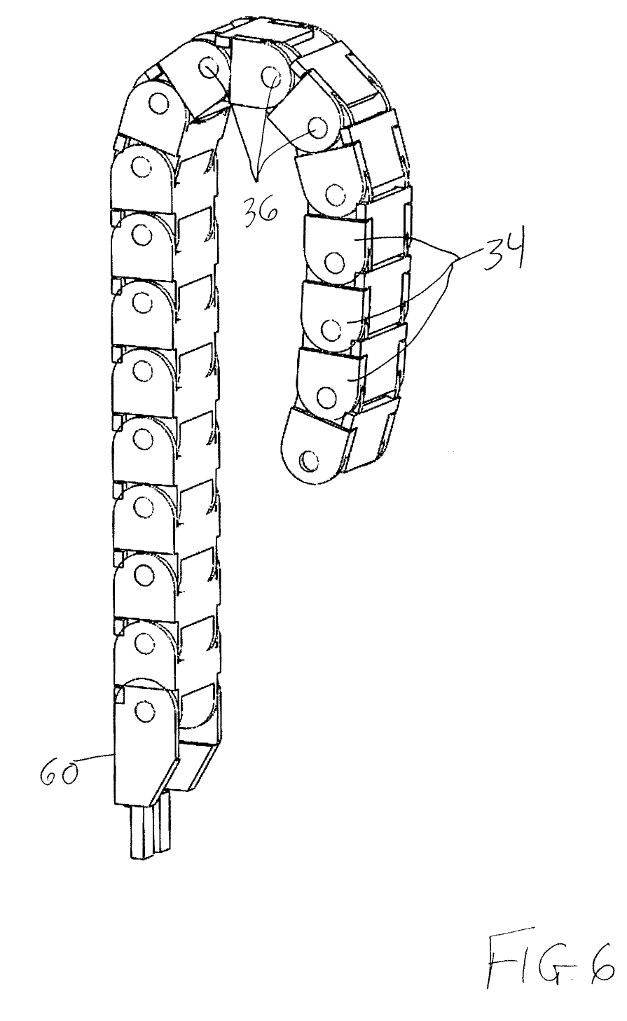

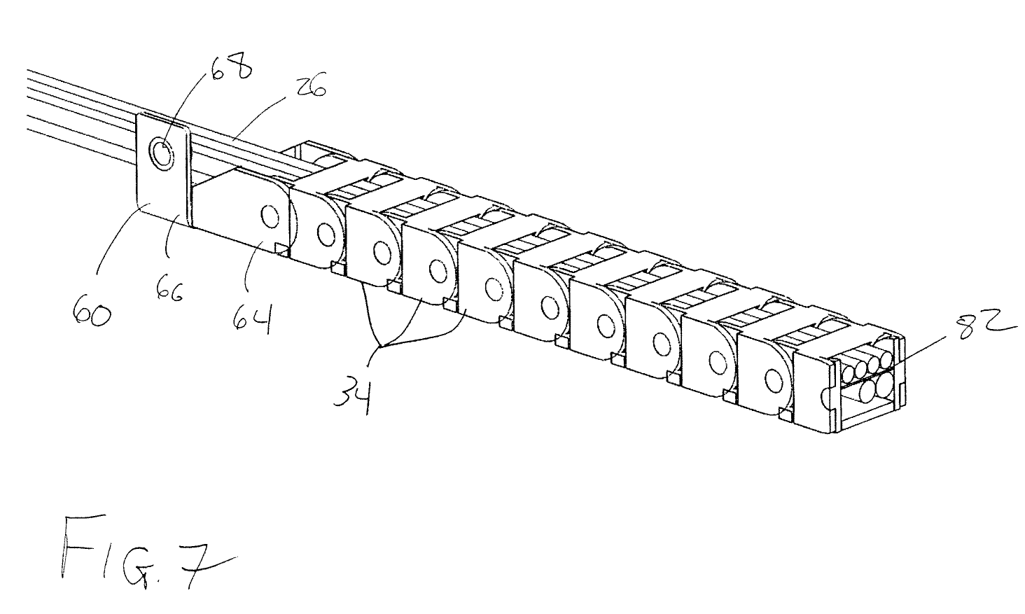

FIG. 6 shows the assembly of the plurality of links. Once the protrusions are inserted in the corresponding apertures 58 of the adjoining links, the plurality of links 34 are pivotally connected to one another at pivot points 36. The flexible cable carrier also has two end pieces 60 and 62 used for attaching the flexible cable carrier to the moveable and fixed parts of the column 14, respectively. FIG. 7 shows the end piece 60 that connects to the vertically fixed part 20 of the column 14. The end piece 60 has upper portions 64 similar to the upper portions 52 of the links 34 so as to mate with the lower portion of the adjoining link. The upper portions 64 of the end piece 60 are then attached to a bracket 66 with an aperture 68 disposed thereon. A fixing mechanism, such as a nail, screw, rivet, or the like, is fed through the aperture 68 and attached to a suitable corresponding mechanism on the fixed part 20 of the column 14.

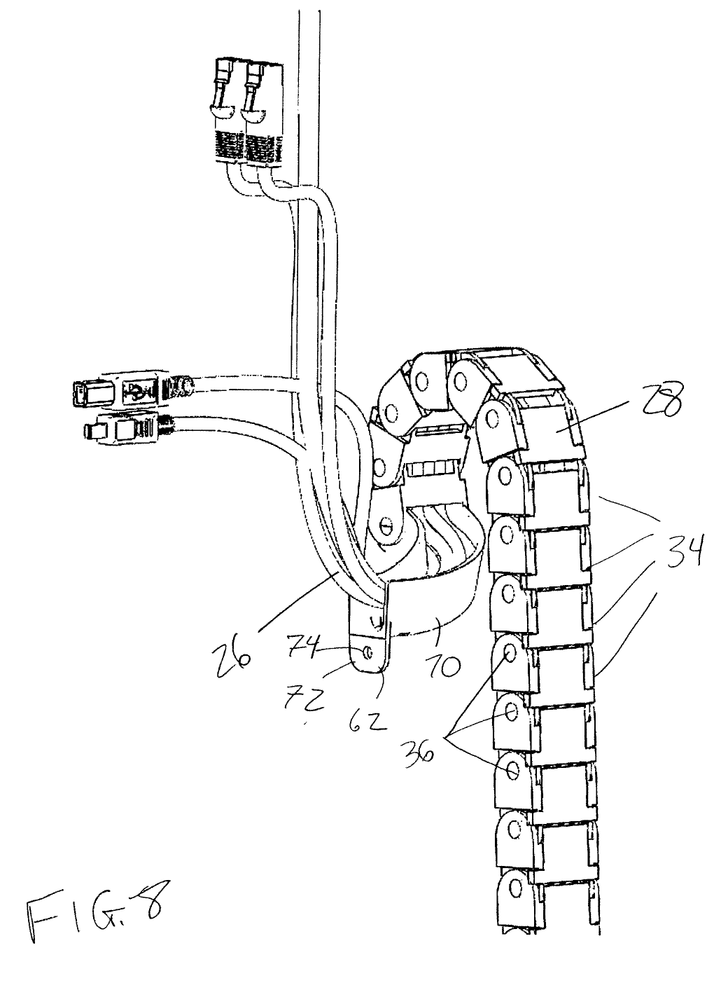

FIG. 8 is a perspective view of a portion of the flexible cable carrier with an end piece 62 that connects to the vertically moveable part 22 of the column 14. The end piece 62 includes a flexible portion 70 that attaches to the adjoining link 34 and a bracket 72. The bracket 72 attaches to the moveable part 22 of the column 14 via an aperture 74 disposed on the bracket 72. A fixing mechanism, such as a nail, screw, rivet, or the like, is fed through the aperture 74 and attached to a suitable corresponding mechanism on the moveable part 22 of the column 14. The flexible portion 70 is flexible enough to permit a wide range of motion. For example, the flexible portion may be plastic, rubber, or cloth. With end pieces 60 and 62, the flexible cable carrier 28 is connected at a lower end to the vertically fixed part 20 of the column 14 and at an upper end to the vertically moveable part 22 of the column 14.

According to one embodiment, more than one layer of cables is used, such as two, as seen in FIG. 7. In such an embodiment, the flexible cable carrier 28 may also include one or more thin plastic strips 82 between the layers, which are used between cable layers to manage the cables.

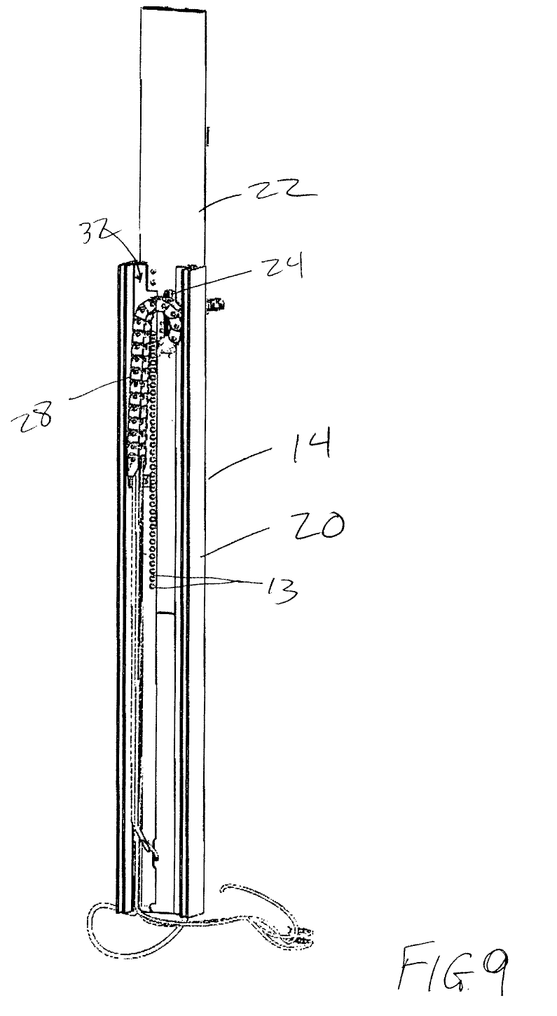

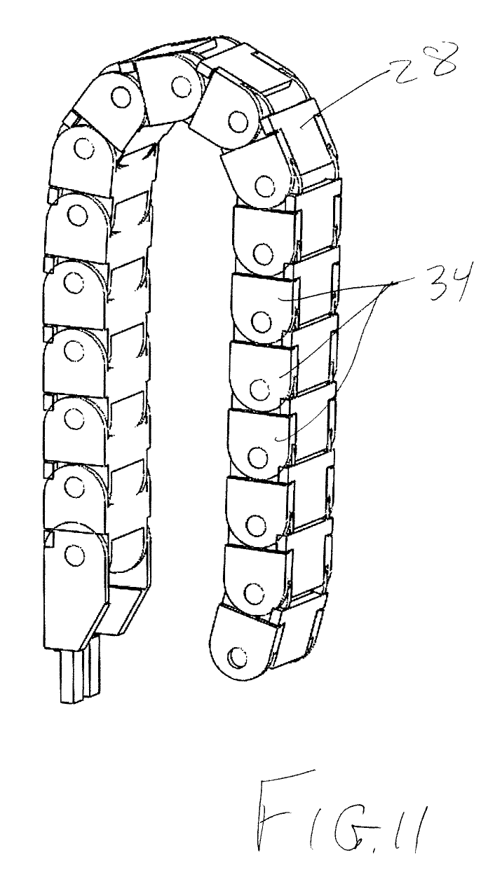

Before or after the insertion of the flexible cable carrier 28 in the column 14 of the cart 1, one or more cables or wires 26 are fed through the plurality of links 34 in between the space created between the side walls 50 and the adjoining walls 51 of the links, as shown in FIG. 8. Upon insertion, the flexible cable carrier 28 (at the very least, the end piece 62 is disposed within the slot 24 in the column 14 so as to attach to the moveable part 22. When assembled and installed in the cart 1, the flexible cable carrier 28 is formed in an inverted J-shape, or a U-shape. FIG. 9 is a cut-away view of the column 14 showing the placement of the flexible cable carrier 28 inserted in the compartment 32 while FIG. 10 is a close-up of the flexible cable carrier 28 of FIG. 9. In FIGS. 9 and 10, the work station is in the raised position, which cause the flexible cable carrier 28 to form a J-shape. When the work station is lowered into the lowered position, as seen in FIG. 2, a portion of the links of the flexible cable carrier 28 pivot as the moveable part 22 is lowered such that the flexible cable carrier 28 forms more of a U-shape, as shown in FIG. 11. The pivoting of the links of the flexible carrier assists the at least one cable 26 connected to the flexible cable carrier 28 to flex in a substantially consistent manner as the moveable part 22 of the column 14 moves up and down. Thus, the flexible cable carrier 28 is configured to cause the at least one cable 26 to follow a substantially consistent path during repeated vertical movements of the work station.

Referring back to FIG. 1, the cart 1 may comprise a base 16. The base 16 is connected to the vertically fixed part 20 of the column 14. The fixed part 20 may be attached to the base 16 by having an end of the fixed part fit inside a hole 42 at a top surface of the base 16. Of course, other methods of attachment are contemplated. The base 18 includes rolling members 30 to facilitate horizontal movement of the cart 1. Such rolling members may be any suitable rotating members, such as wheels or casters. In an alternative embodiment of the present invention, no base 16 need be included such that the cart can be mounted on a wall or other vertical surface.

The disclosed embodiments of the present invention show how the electrical cables or cables for a mobile computing station can be installed during the manufacturing process. Such a configuration enables the end user to easily integrate a computer into the mobile computing station, thus eliminating the need to route electrical cables.

The disclosed embodiments of the present invention includes a channel in a fixed column specifically for the electrical cables. This channel runs the entire length of the column in the vertical direction with exit passageways at the bottom into a base assembly as well as out the rear of the column just above the base assembly. At the top end of the column, the electrical cables are routed into a U-shape or J-shape in order to change directions and provide enough service loop for adjusting the shuttle up and down in the vertical direction. Various methods of maintaining the cables in the U-shape or J-shape portion can be used. Cables that move in such a manner can be managed by using a purchased chain system, or other methods such as cables specifically designed with a shape and stiffness that allows this movement. A simple plastic strip can also be used to keep the cables conforming to the U-shape or J-shape.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A cart comprising:
a vertically moveable work station with a platform;
a column for supporting the work station, wherein the column includes a vertically fixed part and a vertically moveable part that can be moved vertically relative to the vertically fixed part to cause vertical movement of the work station, wherein the column has a vertically oriented opening therein;
at least one cable disposed within the vertically oriented opening in the column; and
a flexible cable carrier disposed within the vertically oriented opening in the column, wherein the at least one cable is connected to the flexible cable carrier and the flexible cable carrier is configured to cause the at least one cable to follow a substantially consistent path during repeated vertical movements of the work station.

2. The cart of claim 1, further comprising a base connected to the vertically fixed part of the column, wherein the base includes rolling members to facilitate horizontal movement of the cart.

3. The cart of claim 1, wherein the vertically oriented opening is formed by a compartment in the column that separates the at least one cable from other components of the column.

4. The cart of claim 1, wherein the vertically oriented opening extends along substantially an entire vertical length of the column.

5. The cart of claim 1, wherein the at least one cable extends along substantially an entire vertical length of the column.

6. The cart of claim 1, wherein the at least one cable is disposed within the flexible cable carrier.

7. The cart of claim 1, wherein the flexible cable carrier is connected at a lower end to the vertically fixed part of the column and at an upper end to the vertically moveable part of the column.

8. The cart of claim 1, wherein the flexible cable carrier is formed in an inverted J-shape.

9. The cart of claim 1, wherein the flexible cable carrier includes a plurality of links that move relative to one another to provide flexibility of the flexible cable carrier.

10. The cart of claim 9, wherein the plurality of links are pivotally connected to one another.
